(19) United States
(12) Patent Application Publication
(10) Pub. No.: US 2009/0043919 A1
(43) Pub. Date: Feb. 12, 2009

(54) Removable device detecting method

(75) Inventor: Tsuyoshi Takimoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/222,300

(22) Filed: Aug. 6, 2008

(30) Foreign Application Priority Data
Aug. 10, 2007 (JP) 2007-210017

(51) Int. Cl. G06F 3/00

(52) U.S. Cl. 710/16

(57) ABSTRACT

According to an aspect of an embodiment, an apparatus includes: a connector for connecting a removable device; a first detector for detecting a change of a signal indicative of a state of a connection between the removable device and the connector; a second detector for detecting acceleration applied to apparatus; and a controller for determining the state of the connection between the removable device and the connector upon detecting the change of the signal and the information of the acceleration.

### BACKGROUND OF THE INVENTION

1. Field of the Invention

An aspect of the invention relates to an apparatus capable of accommodating a removable device.

2. Description of the Related Art

In general, information processing apparatuses allow a variety of recording media and a variety of peripheral devices to be connected thereto. Examples of the recording media include a memory card. The recording media store a variety of data. When a user inserts a recording medium into an information processing apparatus, the information processing apparatus can read out data from the recording medium connected thereto or write data to the recording medium. The information processing apparatus determines whether the recording medium is inserted thereto by determining whether a voltage indicating the insertion is at a power supply voltage level or at a ground level. A terminal of a slot that stores the recording medium is electrically connected to a controller that controls the recording medium via circuit wiring formed on a printed wiring board. A technique related to the above techniques is disclosed in Japanese Laid-open Patent Publication No. 2004-127167 and Japanese Laid-open Patent Publication No. 02-105284.

However, information processing apparatuses are becoming smaller and more integrated. Accordingly, the layout of internal components of information processing apparatuses is limited. As a result, circuit wiring connecting components separated from each other by a large distance is easily affected by noise. If the circuit wiring is affected by noise, the voltage of the circuit wiring varies. This variation in voltage may cause the information processing apparatuses to misrecognize the connection state of a removable device.

### SUMMARY OF THE INVENTION

According to an aspect of an embodiment, an apparatus includes: a connector for connecting a removable device; a first detector for detecting a change of a signal indicative of a state of a connection between the removable device and the connector; a second detector for detecting acceleration applied to apparatus; and a controller for determining the state of the connection between the removable device and the connector upon detecting the change of the signal and the information of the acceleration.

### BRIEF DESCRIPTION OF THE DRAWINGS

FIG. 1 illustrates a relationship between a removal signal and an output of an acceleration sensor when a recording medium is removed;

FIG. 2 is a block diagram of an information processing apparatus according to an embodiment of the invention;

FIG. 3 is a block diagram of programs executed by the information processing apparatus;

FIG. 4 is a block diagram of a card slot;

FIG. 5 illustrates a switch when a recording medium is mounted in the card slot;

FIG. 6 illustrates an example internal structure of the information processing apparatus;

FIG. 7 is a flow chart of processing for acquiring acceleration information about the information processing apparatus;

FIG. 8 illustrates a table for storing an acceleration value;

FIG. 9 is a flow chart of a process performed by a filter driver when the recording medium is removed;

FIG. 10 illustrates an example structure of a card slot direction table;

FIG. 11 is a flow chart of a process performed by a process application;

FIG. 12 is a flow chart of a process performed by the process application for determining whether the recording medium is removed; and

FIG. 13 is a flow chart of a second process performed by the filter driver when the recording medium is removed.

### DESCRIPTION OF THE PREFERRED EMBODIMENTS

An embodiment of the invention is described with reference to the accompanying drawings. Devices connected to an information processing apparatus are peripheral devices and recording media. Examples of the peripheral devices include a printer device and an image scanner device. Examples of recording media include a memory card incorporating a semiconductor memory. Examples of the memory card include a PC card, a secure digital (SD) card, a memory stick, and an xD-picture card. In addition, examples of the recording media include a compact disc (CD) and a digital versatile disc (DVD).

The present embodiment will be described with reference to a recording medium serving as a device connected to the information processing apparatus. However, the invention is not limited to a recording medium. For example, the invention is applicable to other peripheral devices.

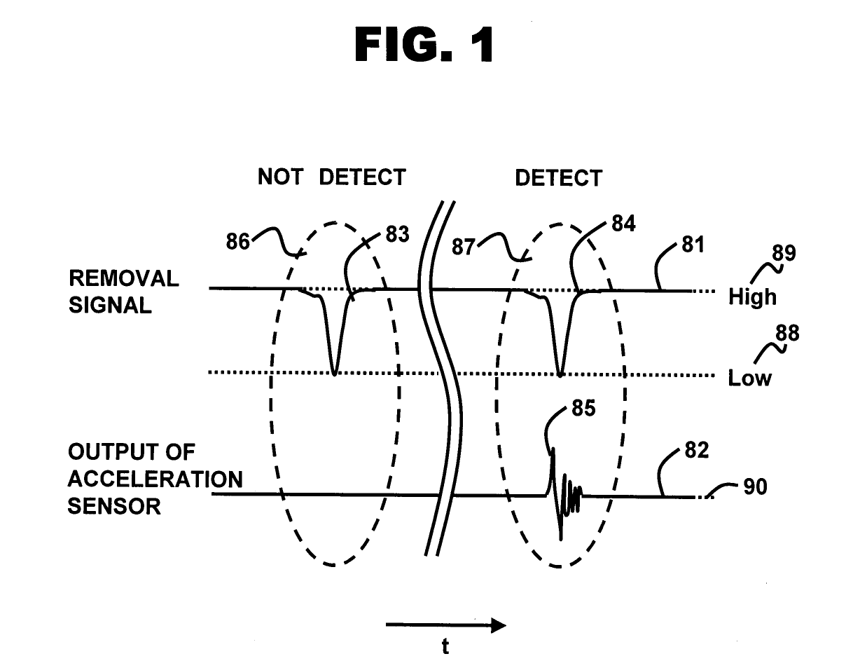

A relationship between a removal signal output when a recording medium is removed from the information processing apparatus according to the present embodiment and an output of an acceleration sensor is described first. FIG. 1 is a diagram illustrating the relationship between the two when the recording medium is removed from the information processing apparatus.

A first detector detects that the recording medium is removed from the information processing apparatus. A removal signal 81 is used for detecting removal of the recording medium. A dotted line 88 represents a ground (Low) level. A dotted line 89 represents a power supply voltage (High) level of the removal signal 81. When the recording medium is removed from the information processing apparatus, the removal signal 81 drops from the power supply voltage level to the ground level. Alternatively, the removal signal 81 may suddenly drop from the power supply voltage level to the ground level due to the adverse effect of noise. Signal changes 83 and 84 of the removal signal 81 occur when the recording medium is removed.

A second detector detects the acceleration of an acceleration sensor 18 mounted in the information processing apparatus. The output of the acceleration sensor 18 is represented by a reference numeral “82”. A dotted line 90 represents the output of the acceleration sensor 18 when the acceleration remains unchanged. A signal change 85 represents the output of the acceleration sensor 18 when the recording medium is removed.

A controller determines whether the recording medium is mounted or removed on the basis of the removal signal 81 and the acceleration information.

More specifically, the controller determines that a recording medium is removed from the information processing apparatus when the controller receives, from the first detector, information indicating that a recording medium is removed and receives, from the second detector, acceleration information indicating that a recording medium is removed. In a state 86, the removal signal 81 is at a Low level. However, the output 82 of the acceleration sensor remains unchanged. In a state 87, the removal signal 81 drops down to a Low level, and the output 82 of the acceleration sensor is changed as indicated by the signal change 85. The controller determines that the recording medium is removed when the state 87 occurs.

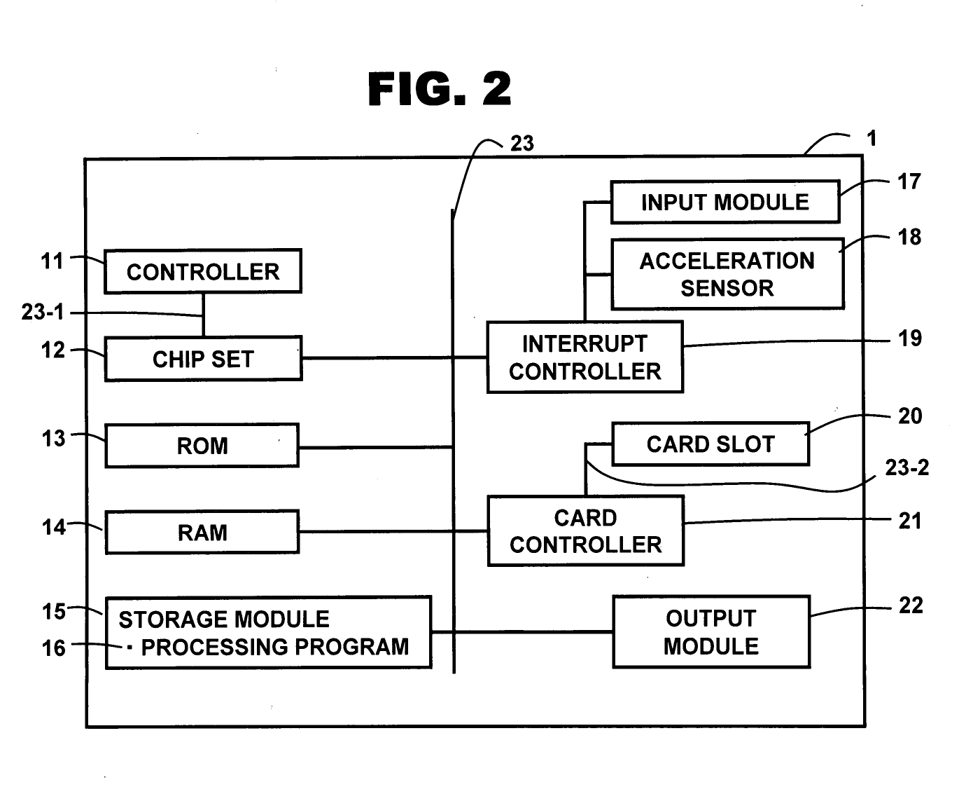

The information processing apparatus that performs the above-described processing is described below. FIG. 2 is a block diagram of an information processing apparatus 1 according to the present embodiment. The information processing apparatus 1 includes the following modules: a controller 11, a chip set 12, a read only memory (ROM) 13, a random access memory (RAM) 14, a storage module 15, an input module 17, an acceleration sensor 18, an interrupt controller 19, a card slot 20, a card controller 21, and an output module 22. The chip set 12, the ROM 13, the RAM 14, the storage module 15, the interrupt controller 19, the card controller 21, and the output module 22 are connected to each other using a bus 23.

The controller 11 performs processing in accordance with a variety of programs loaded into the ROM 13 or the RAM 14. An example of the controller 11 is a central processing unit (CPU).

The chip set 12 controls connection between the controller 11 and each of the modules connected to the chip set 12. A bus 23-1 connects the controller 11 to the chip set 12. For example, the ROM 13, the RAM 14, the storage module 15, the interrupt controller 19, the card controller 21, and the output module 22 are connected to the chip set 12 using the bus 23.

The ROM 13 stores programs and parameters required for the operation of the information processing apparatus 1. For example, the ROM 13 stores a basic input/output system (BIOS). The BIOS is a program that controls peripheral devices connected to the information processing apparatus 1. The RAM 14 temporarily stores programs of an operating system (OS) and some application programs executed by the controller 11.

The storage module 15 stores programs and data used by the information processing apparatus 1. A processing program 16 is executed by the controller 11 in order to detect misrecognition of removal of a recording medium.

The input module 17 includes, for example, a keyboard and a mouse. The input module 17 is operated by a user of the information processing apparatus 1 when, for example, the user inputs a predetermined command and necessary data.

The acceleration sensor 18 detects acceleration. The acceleration sensor 18 can detect accelerations in three axis directions. Each of the three axes is an imaginary straight line extending in a direction in which the acceleration is detected by the acceleration sensor 18. For example, three axes correspond to a length direction, the width direction, and the height direction of the acceleration sensor 18. Accordingly, the acceleration sensor 18 mounted in the information processing apparatus 1 can detect accelerations imparted to the information processing apparatus 1.

In general, the acceleration sensor 18 is mounted in a personal computer serving as the information processing apparatus 1 in order to detect a dropping of the information processing apparatus 1 or a shock applied to the information processing apparatus 1. For example, if the information processing apparatus 1 detects a shock when accessing data stored in a hard disk module, the information processing apparatus 1 unloads the head from the disk. By sending an unload command to the hard disk module, the information processing apparatus 1 can prevent the hard disk module from being damaged. According to the present embodiment, the acceleration sensor 18 mounted in the information processing apparatus 1 detects a shock applied to the card slot 20 via a casing of the information processing apparatus 1 or a printed circuit board 24. In general, in the information processing apparatus 1 in the form of a laptop personal computer, the acceleration sensor 18 can easily detect a shock applied to the card slot 20. However, the present embodiment is applicable to information processing apparatuses other than a laptop personal computer.

The interrupt controller (second detector) 19 receives signals output from the input module 17 and the acceleration sensor 18. The interrupt controller 19 then outputs the received signals to the chip set 12. In addition, the controller 11 is capable of serving as the second detector.

The card slot 20 is a slot formed in the information processing apparatus 1 so as to allow a recording medium removably inserted therein. In addition, the card slot 20 serves as a container that accommodates the recording medium. Furthermore, the card slot 20 serves as an insertion/removal detector (first detector) for detecting insertion and removal of a recording medium. The information processing apparatus 1 can read and write data from and to the inserted recording medium. In addition, the card slot 20 serves as a connector. In addition, the controller 11 is capable of serving as the first detector.

The card controller 21 serves as a control module for controlling access of data stored in a recording medium mounted in the card slot 20. The card controller 21 is connected to the card slot 20 using, for example, a bus 23-2. The card slot 20 sends, to the card controller 21, a signal indicating that a recording medium is inserted or removed.

Examples of the output module 22 include a display module, an audio output module, and a printer device. Examples of the display module include a cathode ray tube (CRT), a liquid crystal display, and a plasma display. An example of the audio output module is a speaker.

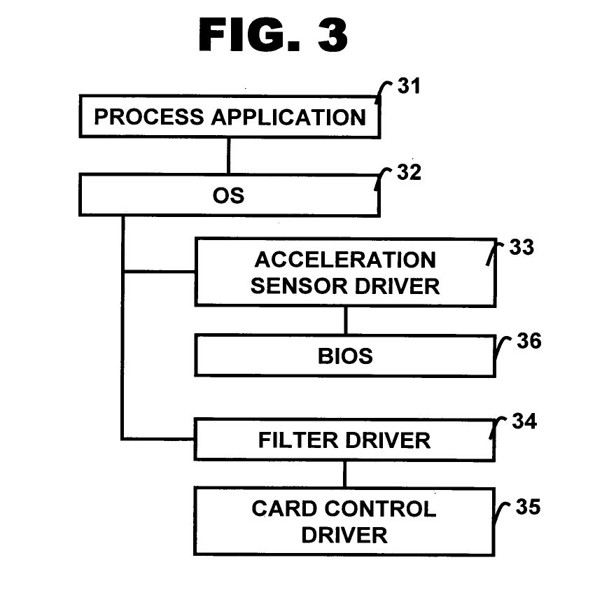

FIG. 3 is a block diagram of programs executed by the information processing apparatus 1.

According to the present embodiment, the programs for the information processing apparatus 1 include a process application 31, an OS 32, an acceleration sensor driver 33, a filter driver 34, and a card control driver 35.

The controller 11 of the information processing apparatus 1 executes the OS 32. The OS 32 is software that provides an abstract interface between application software and hardware. Examples of the hardware include the chip set 12, the ROM 13, the RAM 14, the storage module 15, the interrupt controller 19, the card controller 21, and the output module 22. The application software is executed under the control of the OS 32.

The process application 31 is application software that detects insertion or removal of a recording medium 41. According to the present embodiment, the controller 11 executes the process application 31.

The driver (device driver) is software used for the OS 32 to control the peripheral devices of the information processing apparatus 1. The acceleration sensor driver 33 is a program used for the OS 32 to acquire the acceleration detected by the acceleration sensor 18. The acceleration sensor 18 outputs a voltage value associated with the acceleration. The filter driver 34 is a program that serves as an interface between the OS 32 and the card control driver 35. The card control driver 35 is a grogram for the OS 32 to access data stored in the recording medium 41 mounted in the card slot 20. A BIOS 36 transmits the value received from the acceleration sensor 18 to the acceleration sensor driver 33. According to the present embodiment, the controller 11 executes the acceleration sensor driver 33, the filter driver 34, and the card control driver 35.

According to the present embodiment, the processing program 16 has at least one of the functions of the process application 31, the OS 32, the acceleration sensor driver 33, the filter driver 34, the card control driver 35, and the BIOS 36.

As an example, the process of writing data to the recording medium 41 is described next. As used herein, the term “writing” refers to transfer of data, copy of data, and creation of new data. Upon writing data stored in the storage module 15 to the recording medium 41, the OS 32 requests a writing process of data to the card control driver 35 (hereinafter referred to as a “writing request”). The writing request from the OS 32 to the card control driver 35 is performed via the filter driver 34. The OS 32 sends the writing request to the filter driver 34. The filter driver 34 sends the writing request to the card control driver 35. The card control driver 35 converts the writing request to the address of a recording area of the recording medium 41. The card controller 21 receives the writing request from the card control driver 35. The card controller 21 writes data to the recording area of the recording medium 41 mounted in the card slot 20. In this way, the OS 32 can write data to the recording medium 41.

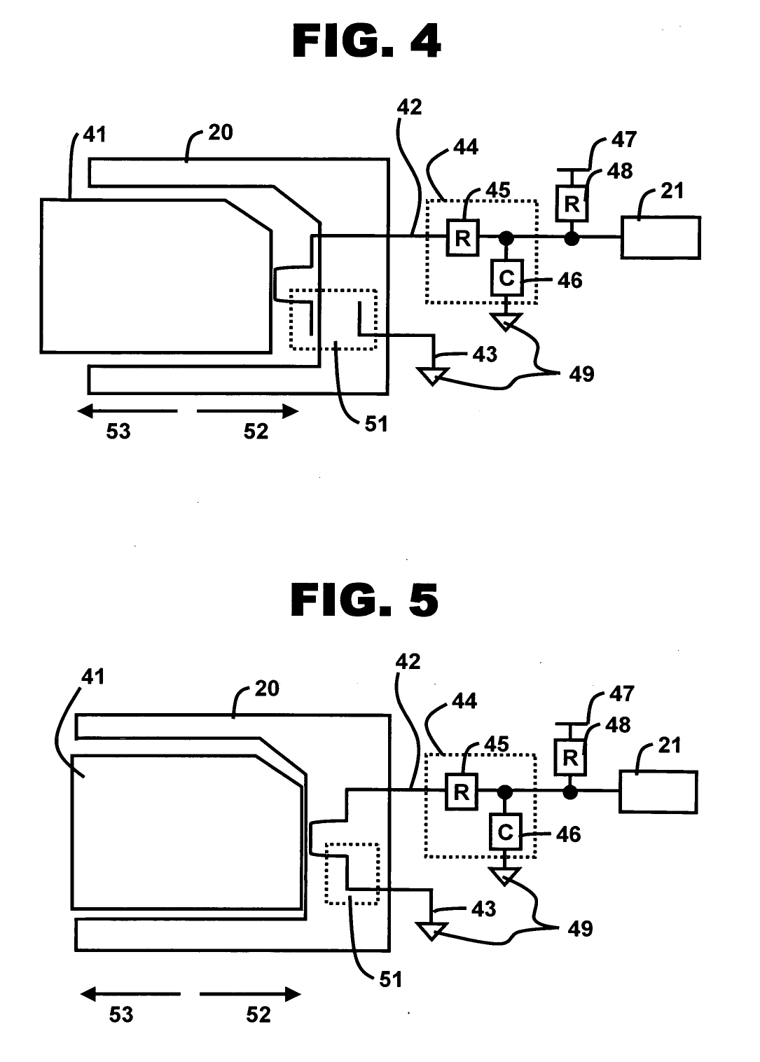

FIG. 4 is a block diagram of the card slot 20.

The recording medium 41 is inserted into the card slot 20 or is removed from the card slot 20. The card slot 20 is electrically connected to the recording medium 41 and accesses data stored in the recording medium 41.

Signal lines 42 and 43 are provided in the card slot 20. The signal line 42 transmits a voltage indicating a connection state between the card slot 20 and the recording medium 41 to the card controller 21. The voltage of the signal line 42 corresponds to the removal signal 81 illustrated in FIG. 1. When the connection state between the card slot 20 and the recording medium 41 varies, the voltage of the signal line 42 varies.

A chattering removal circuit 44 is connected to the signal line 42. Chattering is a phenomenon in which an electrical signal is repeatedly and alternately turned on and off when the recording medium 41 is inserted into the card slot 20 or is removed from the card slot 20. The chattering removal circuit 44 includes a resistor (R) 45 and a capacitor (C) 46. The chattering removal circuit 44 removes chattering of a connection signal regarding the recording medium 41 received by the card controller 21 via the signal line 42.

A resistor (R) 48 is connected between the signal line 42 and a Vcc power supply 47. The Vcc power supply 47 is at the power supply voltage (High) level 89 of the removal signal 81. A signal line 43 is connected to ground 49. The ground 49 is at the ground (Low) level 88 of the removal signal 81. The capacitor 46 is connected between the signal line 42 and the ground 49. The signal line 42 is connected to the card controller 21.

A switch (a determination circuit) 51 is provided in order to detect insertion or removal of the recording medium 41. The signal line 42 is connected to ground by the switch 51, so that the level of the removal signal 81 shown in FIG. 1 is brought to the ground level. Alternatively, the level of the removal signal 81 may be accidentally brought to the ground level due to an adverse effect of noise.

The recording medium 41 is inserted in a direction 52. To insert the recording medium 41 into the card slot 20, a user urges the recording medium 41 in the direction 52. When the recording medium 41 reaches the deepest portion of the card slot 20, the recording medium 41 is returned to a location immediately before the deepest portion. Subsequently, the recording medium 41 is locked at the location immediately before the deepest portion. Since the locking mechanism of the card slot 20 is well known to those skilled in the art, the description is not provided here. Thus, the card slot 20 can electrically access data stored in the locked recording medium 41.

In contrast, the recording medium 41 is removed in a direction 53. To remove the recording medium 41 from the card slot 20, the user urges the recording medium 41 in the direction 52. When the recording medium 41 reaches the deepest portion of the card slot 20, the recording medium 41 is unlocked. Thus, the recording medium 41 is ejected from the card slot 20 in the direction 53.

When the recording medium 41 is locked at the location immediately before the deepest portion, the signal line 42 is not in contact with the signal line 43 in the switch 51. Accordingly, the card controller 21 receives a signal having the power supply voltage (High) level via the signal line 42. When the recording medium 41 is removed from the card slot 20 or the recording medium 41 is inserted into the card slot 20, the recording medium 41 is urged into the deepest portion of the card slot 20. When the recording medium 41 reaches the deepest portion of the card slot 20, the signal line 42 is brought into contact with the signal line 43 in the switch 51. Accordingly, the card controller 21 receives a signal having the ground (Low) level via the signal line 42. In the present embodiment, every time the recording medium 41 reaches the deepest portion of the card slot 20, the signal line 42 is brought into contact with the signal line 43, and therefore, the card controller 21 receives a signal having the ground (Low) level.

FIG. 5 illustrates the switch 51 when the recording medium 41 is mounted in the deepest portion of the card slot 20. When the recording medium 41 is disposed in the deepest portion of the card slot 20, the signal line 42 is in contact with the signal line 43 in the switch 51. As a result, a voltage having the Low level is input to the card controller 21.

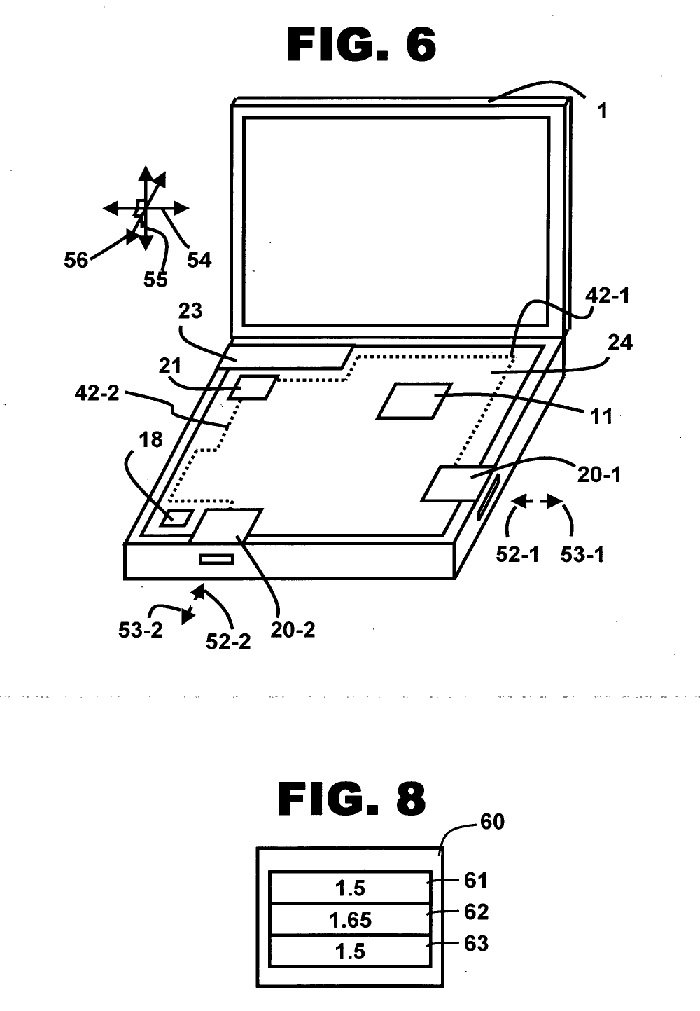

FIG. 6 illustrates an example internal structure of the information processing apparatus 1. According to the present embodiment, the information processing apparatus 1 is a laptop personal computer. A direction 54 represents the width direction of the information processing apparatus 1. A direction 55 represents the height direction of the information processing apparatus 1. A direction 56 represents the depth direction of the information processing apparatus 1.

According to the present embodiment, a printed circuit board 24 of the information processing apparatus 1 includes a power supply circuit 83, the card controller 21, the acceleration sensor 18, card slots 20-1 and 20-2, and the controller 11. In addition, the signal line 42 is formed on the printed circuit board 24.

The acceleration sensor 18 detects accelerations in the following three directions: the direction 54, the direction 55, and the direction 56.

The card controller 21 is electrically connected to the card slot 20-1 using a signal line 42-1. In addition, the card controller 21 is electrically connected to the card slot 20-2 using a signal line 42-2.

A direction 52-1 represents a direction in which the recording medium 41 is inserted into the card slot 20-1. A direction 53-1 represents a direction in which the recording medium 41 is removed from the card slot 20-1.

A direction 52-2 represents a direction in which the recording medium 41 is inserted into the card slot 20-2. A direction 53-2 represents a direction in which the recording medium 41 is removed from the card slot 20-2.

According to the present embodiment, the direction 54, the direction 52-1, and the direction 53-1 are made parallel to the same imaginary line. In addition, according to the present embodiment, the direction 56, the direction 52-2, and the direction 53-2 are made parallel to the same imaginary line.

As noted above, the power supply circuit 83 is provided in the information processing apparatus 1. The power supply circuit 83 supplies electrical power required for the operations of the modules of the information processing apparatus 1. To facilitate the design of the information processing apparatus 1, the card controller 21 is disposed in the vicinity of the power supply circuit 83. The signal lines 42-1 and 42-2 connected to the card controller 21 are formed in the vicinity of the power supply circuit 83.

The noise occurring on the signal line 42 is described next. An example of the noise is chattering occurring when the recording medium 41 is inserted and removed. The chattering can be prevented by the chattering removal circuit 44. In addition, noise may occur due to interference caused by other signals. The noise caused by other signals can be reduced to some extent by using a capacitor. However, in small information processing apparatuses, the layout of a printed circuit board is limited. Accordingly, the length of a wiring may be increased. In addition, under such unavoidable circumstances, the circuit wiring needs to be formed in a region where noise easily occurs. Examples of a region where noise easily occurs include a power supply circuit. Since suspend and resume operations of an information processing apparatus cause an electrical current flowing in the information processing apparatus to vary markedly, noise tends to occur. If the layout of a printed circuit board is limited, a capacitor cannot prevent the adverse effect of noise.

Furthermore, noise may be generated by another factor in addition to the power supply circuit. For example, static electrical charge carried by an operator may generate noise. Still furthermore, noise may be generated by a surrounding environment of the information processing apparatus 1. Accordingly, noise may be generated by a factor other than the close proximity of the signal line 42 to the power supply circuit 83 in the information processing apparatus 1. If the signal line 42 is subjected to noise, the level of the voltage of the signal line 42 instantaneously drops. When the voltage value decreases, the card controller 21 recognizes that the recording medium 41 is inserted into the card slot 20 or is removed from the card slot 20.

The processing performed by the controller 11 of the information processing apparatus 1 according to the present embodiment is described next. The controller 11 executes a variety of programs loaded on the RAM 14 and the ROM 13. Examples of the programs include the process application 31, the OS 32, the acceleration sensor driver 33, the filter driver 34, the card control driver 35, and the BIOS 36. Each of the programs is executed by the controller 11 so as to provide its function. In practice, in the information processing apparatus 1, the controller 11 executes each of the programs. Hereinafter, for simplicity, only the operations of the process application 31, the OS 32, the acceleration sensor driver 33, the filter driver 34, and the card control driver 35 are described.

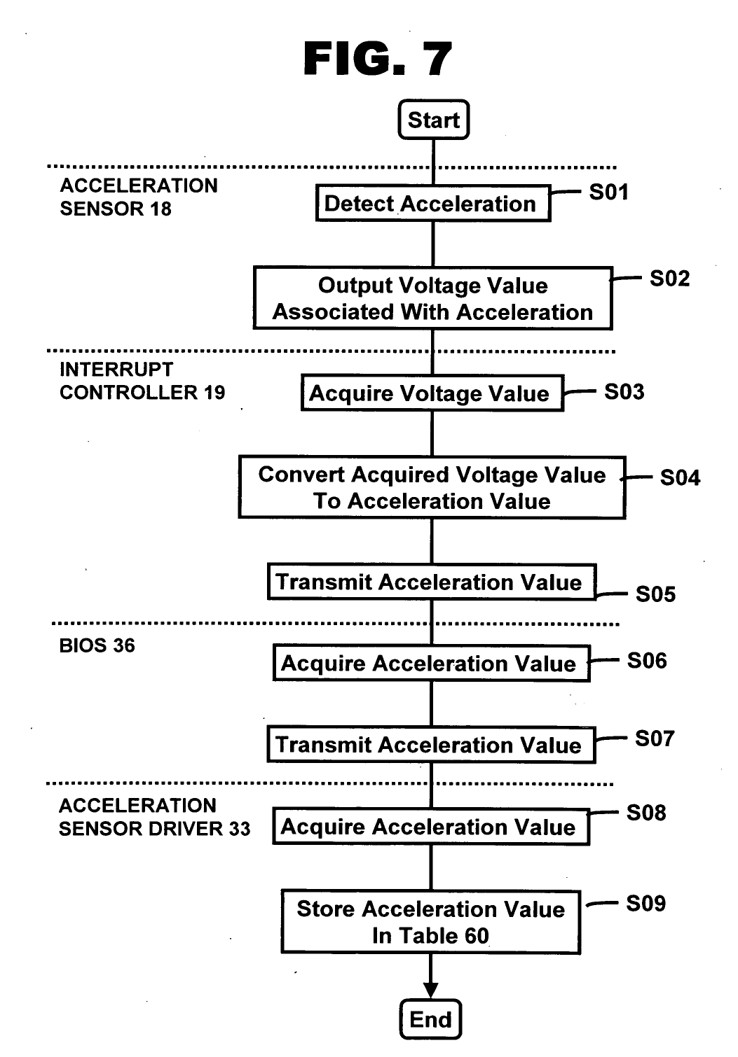

The processing performed by the acceleration sensor 18 is described next. If the OS 32 can directly sense the output of the acceleration sensor 18, the OS 32 can acquire the output of the acceleration sensor 18. However, if the OS 32 cannot directly sense the output of the acceleration sensor 18, the OS 32 performs the following processing. FIG. 7 is a flow chart of processing for acquiring acceleration information about the information processing apparatus 1.

The acceleration sensor 18 detects acceleration (step S01). The acceleration sensor 18 then outputs a voltage value associated with the acceleration (step S02). The interrupt controller 19 is brought into connection to the acceleration sensor 18 so as to acquire the output of the acceleration sensor 18 (step S03). The interrupt controller 19 converts the acquired voltage value to an acceleration value (step S04). Thereafter, the interrupt controller 19 transmits the acceleration value to the BIOS 36 (step S05).

The BIOS 36 acquires the acceleration value from the interrupt controller 19 (step S06). The BIOS 36 then transmits the acceleration value to the acceleration sensor driver 33 (step S07). The BIOS 36 is used because a module suitable for receiving the acceleration value is not present. Therefore, if the acceleration sensor driver 33 can directly acquire the acceleration value, the need for the BIOS 36 is eliminated.

The acceleration sensor driver 33 acquires the acceleration value via the BIOS 36 (step S08). The acceleration sensor driver 33 then stores the acceleration value acquired via the BIOS 36 in a table (step S09).

The table for storing the acceleration value is described next. FIG. 8 illustrates a table 60 for storing the acceleration value. The acceleration sensor 18 outputs information indicating the acceleration for each of the directions. A value 61 indicates the acceleration in the direction 54. A value 62 indicates the acceleration in the direction 55. A value 63 indicates the acceleration in the direction 56. For example, the acceleration sensor driver 33 receives, from the acceleration sensor 18, a value ranging from 0 to 3.0. A value of 1.5 represents a central value indicating that no variation in acceleration occurs.

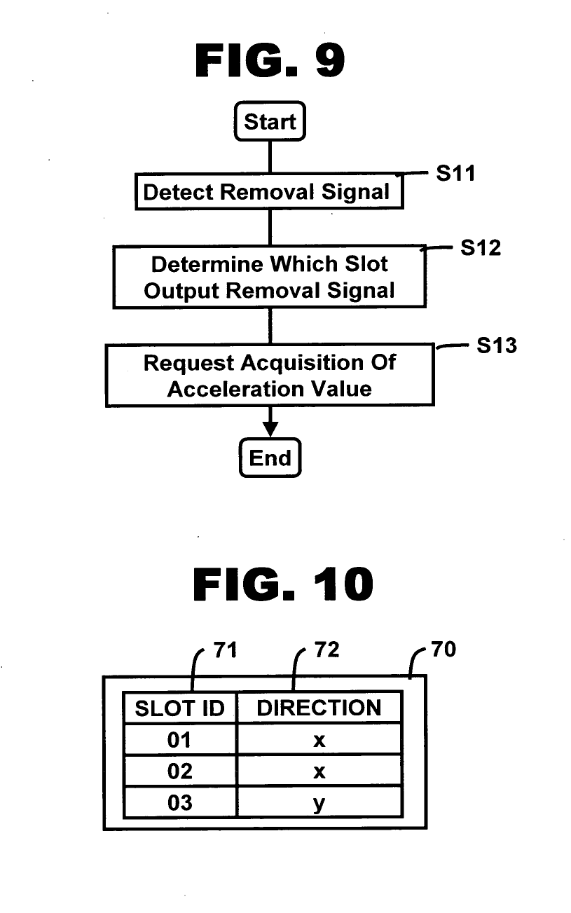

The processing performed when the recording medium 41 is removed from the information processing apparatus 1 is described next. FIG. 9 is a flow chart of a process performed by the filter driver 34 when the recording medium 41 is removed.

The filter driver 34 detects a removal signal (step S11). This removal signal indicating removal of the recording medium 41 is detected when the voltage level of the signal line 42 connected to the card controller 21 becomes Low. The filter driver 34 then determines which slot of the information processing apparatus 1 output the removal signal (step S12).

FIG. 10 illustrates an example structure of a card slot direction table 70. For example, the card slot direction table 70 is loaded into the RAM 14. The card slot direction table 70 includes an identification number 71 for identifying a slot and a direction 72 in which the recording medium 41 is inserted into or removed from the slot.

The filter driver 34 enters a mode in which the filter driver 34 requests acquisition of an acceleration value (step S13). This is because, in the present embodiment, the filter driver 34 does not actively send an acquisition request to the OS 32.

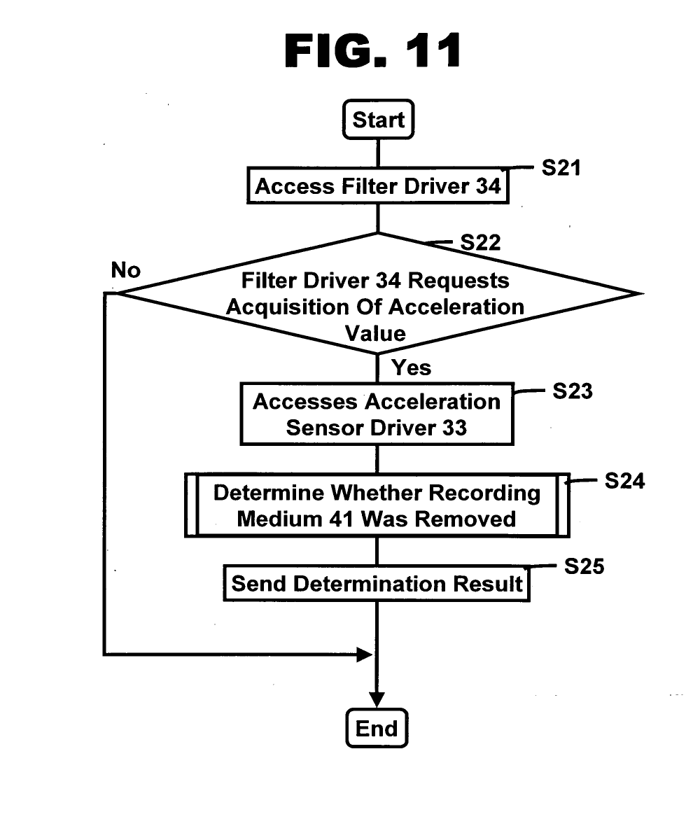

The processing performed by the process application 31 is described next. FIG. 11 is a flow chart of a process performed by the process application 31. The process application 31 accesses the filter driver 34 (step S21). In the information processing apparatus 1 according to the present embodiment, the filter driver 34 does not send request information. Accordingly, for example, the process application 31 accesses the filter driver 34 at predetermined intervals. Subsequently, the process application 31 determines whether the filter driver 34 is in the mode in which the filter driver 34 requests acquisition of an acceleration value (step S22).

If the filter driver 34 is in the mode in which the filter driver 34 does not request acquisition of an acceleration value (“No” in step S22), the process performed by the process application 31 is completed. For example, the process application 31 starts the process starting from step S21 again after a predetermined time has elapsed.

However, if the filter driver 34 is in the mode in which the filter driver 34 requests acquisition of an acceleration value (“Yes” in step S22), the process application 31 accesses the acceleration sensor driver 33 (step S23). The mode in which the filter driver 34 requests acquisition of an acceleration value is a mode indicating that the filter driver 34 has detected the removal signal for the recording medium 41. Accordingly, the process application 31 acquires the value of acceleration applied to the information processing apparatus 1 when the removal signal for the recording medium 41 is detected. The process application 31 acquires the acceleration value from the acceleration sensor driver 33 so as to determine whether the recording medium 41 was removed (step S24).

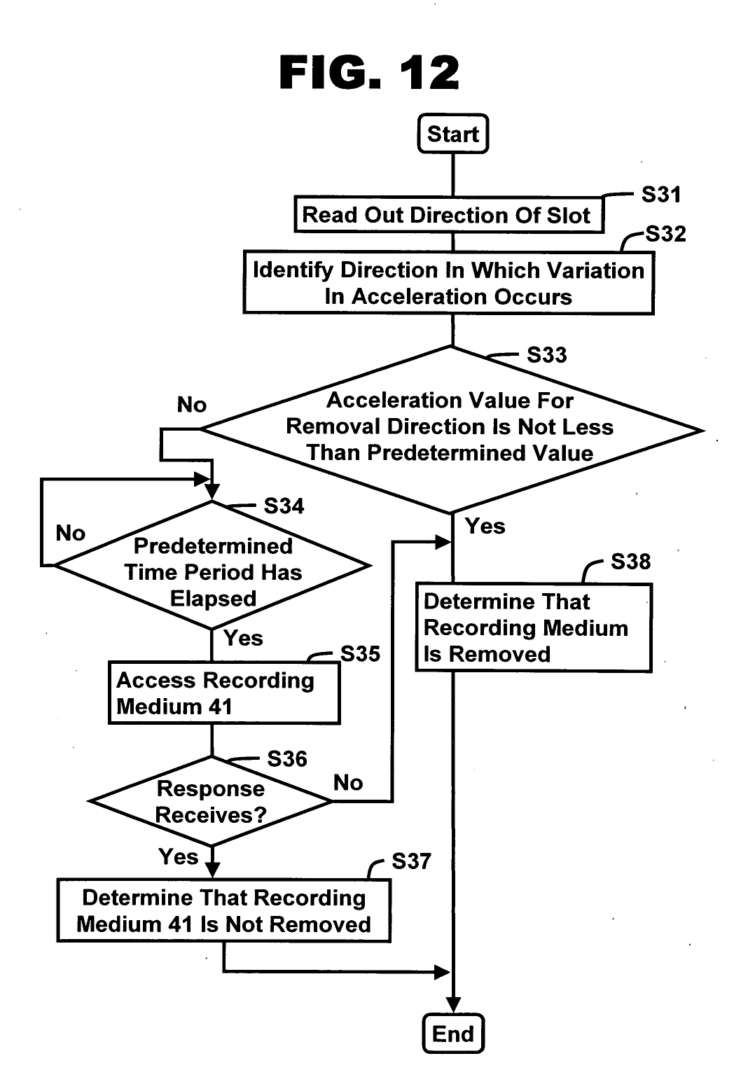

A process performed by the process application 31 for determining whether the recording medium 41 is removed is described next. FIG. 12 is a flow chart of the process performed by the process application 31 for determining whether the recording medium 41 is removed. The process application 31 reads out the information about the direction of a slot for the recording medium 41 (step S31). More specifically, the process application 31 reads out the information about the direction 72 from the card slot direction table 70 associated with the recording medium 41 for which the process application 31 detects a removal signal.

Subsequently, the process application 31 identifies a direction in which a variation in acceleration occurs (step S32). More specifically, the process application 31 requests the acceleration sensor driver 33 to acquire the acceleration values. The acceleration sensor driver 33 sends, to the process application 31, the values 61, 62, and 63, which are the acceleration values for all of the directions stored in the table 60. The process application 31 then determines whether the acceleration values are greater than or equal to a predetermined value. The predetermined value is determined on the basis of a magnitude of a shock applied to the information processing apparatus 1 when the recording medium 41 is removed from the card slot 20. The magnitude of a shock is obtained in advance through, for example, an experiment. The process application 31 identifies a direction in which acceleration higher than or equal to the predetermined value occurs.

In an alternative configuration, the process application 31 may detect a shock using pattern matching of the variation in acceleration. In this case, the table 60 can store the acceleration values obtained from the acceleration sensor 18 at a plurality of points of time. The process application 31 prestores the waveform indicating the variation in acceleration occurring when the recording medium 41 is removed from the card slot 20. The process application 31 performs a matching process between a waveform generated by connecting the plurality of obtained acceleration values and the prestored waveform indicating the variation in acceleration. When the waveforms match, the process application 31 determines that the recording medium 41 is removed.

The process application 31 determines whether the acceleration value for the removal direction is greater than or equal to the predetermined value (step S33). More specifically, the process application 31 determines in step S33 whether the acceleration value in the direction 72 identified in step S32 for the recording medium 41 for which the removal signal is detected is greater than or equal to the predetermined value.

If the acceleration in the removal direction of the recording medium 41 is greater than or equal to the predetermined value (“Yes” in step S33), the process application 31 determines that the recording medium 41 is removed (step S38).

However, if the acceleration in the removal direction of the recording medium 41 is not greater than or equal to the predetermined value (“No” in step S33), the process application 31 performs the following processing. That is, the process application 31 waits until a predetermined time period has elapsed (“No” in step S34). After the process application 31 waits until a predetermined time period has elapsed (“Yes” in step S34), the process application 31 accesses the recording medium 41 (step S35). In some cases, even when the recording medium 41 is removed, the acceleration sensor 18 cannot detect acceleration. For example, if a shock in a direction opposite the direction of the shock caused by removal of the recording medium 41 is applied to the information processing apparatus 1, the shocks cancel each other out. Thus, a variation in acceleration does not occur. In such a case, although the acceleration sensor 18 does not detect a variation in acceleration, the recording medium 41 is removed from the information processing apparatus 1. Therefore, the process application 31 accesses the recording medium 41 again so as to detect the presence of the recording medium 41.

If the process application 31 receives a response to the access of the recording medium 41 (“Yes” in step S36), the process application 31 determines that the recording medium 41 is not removed (step S37). However, if the process application 31 receives no response to the access of the recording medium 41 (“No” in step S36), the process application 31 determines that the recording medium 41 is removed (step S38). Referring back to the flow chart of FIG. 11, the process application 31 sends, to the filter driver 34, information as to whether or not the recording medium 41 is removed (step S25).

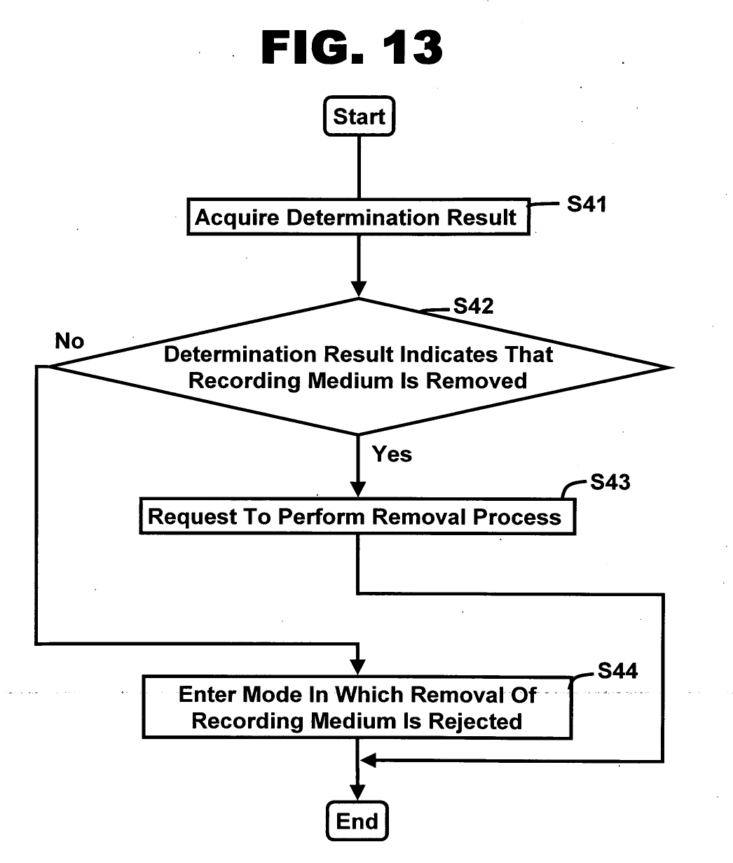

The processing performed by the filter driver 34 after the filter driver 34 receives the determination result obtained in step S25 is described next. FIG. 13 is a flow chart of the second process performed by the filter driver 34 when the recording medium 41 is removed. The filter driver 34 acquires the determination result from the process application 31 via the OS 32 (step S41). The filter driver 34 then determines whether the recording medium 41 is removed.

If the filter driver 34 acquires a determination result indicating that the recording medium 41 is removed (“Yes” in step S42), the filter driver 34 requests the card control driver 35 to perform a removal process (step S43). For example, the removal process includes a series of post-processing, such as a termination process of the card control driver 35 loaded in the RAM 14.

However, if the filter driver 34 acquires a determination result indicating that the recording medium 41 is not removed (“No” in step S42), the filter driver 34 enters a mode in which removal of the recording medium 41 is rejected for the OS 32 (step S44). Upon accessing the filter driver 34, the OS 32 receives information indicating rejection of removal of the recording medium 41.

If the signal line 42 is affected by noise and the card controller 21 misrecognizes insertion of the recording medium 41 although the recording medium 41 is not mounted, the following processing is performed. Upon acquiring a detection signal of the recording medium 41, the card controller 21 executes a program for accessing data stored in the recording medium 41. However, since the recording medium 41 is not present, the program executed by the card controller 21 outputs an error status. Thereafter, the processing is completed. Accordingly, there is no problem when insertion of the recording medium 41 is misrecognized although the recording medium 41 is not mounted.

In contrast, if the card controller 21 detects removal of the recording medium 41, the card controller 21 stops accessing data stored in the recording medium 41. Although the recording medium 41 is present, subsequent writing of data to the recording medium 41 is impossible. In order to write data to the recording medium 41 again, the recording medium 41 needs to be removed and inserted again. For example, in a manufacturing factory of the information processing apparatus 1, the information processing apparatus 1 is inspected and it is determined whether it can be shipped as a final product. Examples of the inspection include an insertion/removal test of the recording medium 41 and a switching test between a suspend mode and a resume mode. In general, the inspection is performed by executing a test program that causes the information processing apparatus 1 to perform the operations corresponding to a series of test operations. During the inspection, if removal of the recording medium 41 is misrecognized, the test program is abnormally terminated. If the test program is abnormally terminated, the information processing apparatus 1 is regarded as a defective product. The information processing apparatus 1 needs to be inspected again. As a result, although the information processing apparatus 1 does not malfunction, the information processing apparatus 1 is regarded as a defective product. The manufacturing time is wasted, and the manufacturing costs are increased.

According to the present embodiment, in the information processing apparatus 1, removal of the recording medium 41 is determined in cooperation with a result of detection performed by the acceleration sensor 18. Accordingly, actual removal of the recording medium 41 can be determined. Even when the information processing apparatus 1 detects a removal signal of the recording medium 41 in the case where the information processing apparatus 1 is stationary, such as when the information processing apparatus 1 is subjected to shipping inspection, the information processing apparatus 1 can determine that the recording medium 41 is not removed, since no variation in acceleration occurs.

While the present embodiment has been described with reference to a recording medium serving as a removable device of an information processing apparatus, the present embodiment can be applied to a determination process of removal of a universal serial bus (USB)-based peripheral device. For example, when the information processing apparatus 1 includes a plurality of USB connectors, the information processing apparatus 1 prestores the insertion/removal directions of the USB connectors. If the information processing apparatus 1 cannot detect a peripheral device connected to one of the USB connectors, the information processing apparatus 1 acquires the acceleration of the acceleration sensor 18. If the acceleration is greater than or equal to a predetermined value, the information processing apparatus 1 determines that the peripheral device is removed from the USB connector.

In addition, a threshold value (i.e., the predetermined value used in step S33) used for detecting the acceleration occurring when a removable device is removed from the information processing apparatus 1 can be differently set for each of the removable devices connected to the information processing apparatus 1. For example, if the connecting force between the information processing apparatus 1 and a removable device is strong, and therefore, a large force is required for removing the removable device, a larger acceleration occurs. Therefore, in accordance with a connecting force, the threshold value of the acceleration used for determining whether a device is removed from the information processing apparatus 1 may be changed. The threshold value of the acceleration for each of the devices is stored in advance. For example, the threshold value of the acceleration may be stored in the card slot direction table 70.

What is claimed is:

1. An apparatus comprising:
a connector for connecting a removable device;
a first detector for detecting a change of a signal indicative of a state of a connection between the removable device and the connector;
a second detector for detecting acceleration applied to apparatus; and
a controller for determining the state of the connection between the removable device and the connector upon detecting the change of the signal and the information of the acceleration.

2. The apparatus according to claim 1, wherein the controller determines the change of the connection state of the removable device when the controller detects occurrence of the change of the signal of the removable device and the acceleration of the apparatus at the same time.

3. The apparatus according to claim 1, wherein the controller determines the change of the connection state of the removable device when the removable device is removed from the connector.

4. The apparatus according to claim 1, wherein the controller determines the connection state when the controller receives from the first detector the change of the connection state of the removable device indicating that the removable device is removed from the apparatus and the controller receives from the second detector the acceleration generated when the removable device is removed.

5. The apparatus according to claim 1, wherein the second detector detects the acceleration of a direction in which the removable device is mounted or removed to the apparatus.

6. A method for controlling an apparatus having a connector for connecting a removable device, comprising:
detecting a change of a signal indicative of a state of a connection between the removable device and the connector;
detecting acceleration applied to the apparatus; and
determining a connection state between the removable device and the connector upon detecting the change of the signal and the information of the acceleration.

7. The method according to claim 6, wherein the determining step determines the change of the connection state of the removable device when the determining detects the change of the signal of the removable device and the acceleration of the apparatus at the same time.

8. The method according to claim 6, wherein the determining step determines the connection state of the change occurring when the removable device is removed from the connector.

9. The method according to claim 6, wherein the determining step determines the change of the connection state when the controller receives from the first detector the change of the connection state of the removable device indicating that the removable device is removed from the apparatus and the controller receives from the second detector the acceleration generated when the removable device is removed.

10. The method according to claim 6, wherein the detecting step detects the acceleration in a direction in which the removable device is mounted or removed.
